(19) United States
(12) Patent Application Publication
(10) Pub. No.: US 2007/0104983 A1
(43) Pub. Date: May 10, 2007

(54) Fuel cell system

(76) Inventors: Hidenobu Wakita, Yawata-shi (JP); Yukimune Kani, Moriguchi-shi (JP); Seiji Fujihara, Amagasaki-shi (JP); Kiyoshi Taguchi, Osaka-shi (JP); Kunihiro Ukai, Ikoma-shi (JP)

Correspondence Address: AKIN GUMP STRAUSS HAUER & FELD LLP;PANASONIC, ONE COMMERCE SQUARE, 2005 MARKET STREET SUITE 2200, PHILADELPHIA, PA, 19103, US

(21) Appl. No.: 10/561,778

(22) PCT Filed: Nov. 18, 2004
(86) PCT No.: PCT/JP04/17141

§ 371 Date: Dec. 20, 2005

(30) Foreign Application Priority Data
Dec. 3, 2003 (JP) 2003-405016

(51) Int. Cl. H01M 8/06

(52) U.S. Cl. 429/19; 429/20

(57) ABSTRACT

A fuel cell system of the present invention comprises a reformer (1) configured to generate a hydrogen-rich gas, a shift converter (2) configured to generate hydrogen and carbon dioxide from carbon monoxide in the hydrogen-rich gas and water, a hydrogen generator (20) including a carbon monoxide removing portion (3) configured to reduce the carbon monoxide in the hydrogen-rich gas which has not been removed in said shift converter (2), a fuel cell (4) configured to generate power using the hydrogen-rich gas supplied from the hydrogen generator (20) and an oxidizing gas, an air supply portion (6, 9) configured to supply air to at least one of a position upstream of said reformer (1) and a position between said carbon monoxide removing portion (3) and said fuel cell (4) in a flow of the fuel gas; and an impurity removing means (12, 13) configured to remove an impurity gas from the air.

### TECHNICAL FIELD

The present invention relates to a fuel cell system. More particularly, the present invention relates to a fuel cell system that includes a hydrogen generator configured to cause a fuel containing hydrocarbon and water to flow through a catalyst to generate a hydrogen-rich gas containing carbon monoxide and that is configured to remove an impurity gas from air flowing through a reformer within the hydrogen generator or an anode.

### BACKGROUND ART

Various types of fuel cell systems that generate power using hydrogen and oxygen in air have been developed. Fuel cell systems employed at home or the like are typically configured as described below. First, methane, ethane, propane, butane, a city gas, a LP gas, and other hydrocarbon gas (containing a gas mixture of two or more kinds of hydrocarbons) is reformed in a reformer to generate a hydrogen-rich gas.

A reforming method includes a steam reforming method that reforms the hydrocarbon gas using steam, a partial oxidation method that reforms the hydrocarbon gas using oxygen in air, and an autothermal method including a combination of these two methods.

The hydrogen-rich gas generated in these reforming methods typically contains 8 to 15% (concentration based on capacity) carbon monoxide (hereinafter referred to as CO) as a side-reaction product, which may vary depending on the performance of the reformer. The concentration of the CO contained in the hydrogen-rich gas which is supplied to, for example, a polymer electrolyte fuel cell (hereinafter referred to as PEFC) is required to be limited to approximately 50 ppm. When the concentration is above approximately 50 ppm, performance of the fuel cell significantly degrades. It is therefore necessary to remove the CO as much as possible before the hydrogen-rich gas is introduced to the PEFC.

In order to remove this side-reaction product CO, the hydrogen-rich gas generated in the reforming method is led to a shift converter. In the shift converter, the CO is converted into carbon dioxide and hydrogen through a shift reaction (see Formula (1)). The hydrogen-rich gas, from which the CO has not been completely removed in the shift converter, contains a minute amount of CO. For this reason, in a CO selective oxidation portion, an oxidizing gas such as air is added to cause CO selective oxidation (see formula (2) below) to occur to reduce the concentration of the CO of the hydrogen-rich gas to 50 ppm or less, preferably 10 ppm or less. The resulting hydrogen-rich gas is supplied to an anode of the PEFC.

Against an increase in CO concentration, for example, due to fluctuation of a load, air is commonly supplied to the anode to conduct air-breathing in order to inhibit CO poisoning in an anode electrocatalyst.
CO+H₂O→CO₂+H₂ (1)
CO+1/2O₂→CO₂ (2)

It is desirable to stop components in a fuel cell for household use to increase efficiency when power consumption is less. In a stopped state of the fuel cell, it is necessary to purge a remaining combustible gas such as the hydrogen-rich gas, from the interior of the fuel cell system, using an incombustible gas for the purpose of safety. Since it is difficult to install a N₂ cylinder at the fuel cell for household use, there has been disclosed a method in which the remaining gas is purged from the hydrogen generator, an anode passage using steam, and then the steam is purged therefrom using air in a temperature range in which steam condensation does not occur.

As described above, air is supplied to various components within the fuel cell system. If the air containing an impurity such as an organic solvent is supplied to a cathode of the PEFC, then oxygen adsorbability of a cathode electrode is degraded, because the organic solvent is not decomposed in a cathode electrocatalyst. This may lead to degraded characteristics or reduced life of the fuel cell. As a solution to this, there has been disclosed a catalytic combustor that removes organic solvents such as kerosine from the air before being supplied to the cathode (see for example, patent document 1).

Also, there has been disclosed a CO remover that removes impurities from air for CO selective oxidation which is supplied to the CO selective oxidation portion as the oxidizing gas in order to inhibit CO poisoning in the anode, which may be due to the fact that organic substances such as HCHO or NOx or SOx which is contained in the air poisons the CO selective oxidation catalyst and thereby characteristic of the CO selective oxidation catalyst degrades, and a fuel cell system using the CO remover (see for example, patent document No. 2).

Patent document 1: Japanese Laid-Open Patent Application Publication No. 2000-277139

Patent document 2: Japanese Laid-Open Patent Application Publication No. 2000-327305

### DISCLOSURE OF THE INVENTION

Problems to be Solved by the Invention

In fuel cell systems other than the fuel cell systems disclosed in the above patent documents, impurities contained in the air supplied to the interior of the fuel cell system may also arise problems. By way of example, air for anode air-breathing will be described.

The supply amount of the air for the anode air-breathing is less than the supply amount of the air supplied to the cathode of the fuel cell. In the case of the fuel cell of 1 kW, the supply amount of the air to the cathode is 65 Nl/min (hereinbelow expressed in this way in terms of 0° C. and 0.1 MPa), while the supply amount of the air for anode air-breathing is 0.3 Nl/min.

Exemplary impurities contained in the air are inorganic gases such as sulfur oxide, hydrogen sulfide, nitrogen oxide, and ammonia, and organic gases such as amine, fatty acid, aromatic compounds, and aldehyde. The concentration of these impurity gases in atmospheric air is as low as several tens ppm to several ppb.

However, in a case where the impurities in the air are substances such as sulfur compounds, i.e., so-called permanent poisoning substances, which irreversibly degrade a catalyst, active site of the catalyst will be covered with them and thereby catalyst characteristic will be finally degraded, if the catalyst is exposed to the air for a long time period of, for example, several tens thousands hours, regardless of the small air supply amount and the low concentration of the permanent poisoning substances in the air.

It is believed that the permanent poisoning substance poisons a noble metal catalyst noticeably, if it covers an exposed surface of the noble metal in a ratio of approximately 1/several tens to 1/2. In a fuel cell of 1 kW, noble metals of Pt and Ru used as an anode catalyst of the fuel cell are respectively 0.2 mol. If air containing 0.5 ppm hydrogen sulfide is supplied to the anode at 0.3 Nl/min for air-breathing, poisoning substances are accumulated to the amount that may negatively affect the catalyst characteristic in several thousands to several tens thousands hours.

Hereinbelow, how the electrocatalyst of the anode in the fuel cell is poisoned will be described.

Among sulfur compounds, for example, sulfur oxide and hydrogen sulfide have standard potentials (vs. SHE (Standard Hydrogen Electrode)) represented below, and hydrogen sulfide is adsorbed on metal as S²⁻ and poisons the metal.
SO₄²⁻+H₂O+2e⁻⇄SO₃²⁻+2OH⁻−0.93V
S²⁻+2H⁺+2e⁻⇄H₂S(aq)0.141V

Since the potential of the anode is 0V, SO₂ becomes SO₄²⁻ at the anode, which affects less because a polymer electrolyte is made of sulfonic acid salt. However, since H₂S is stable at 0V, oxidation characteristic of hydrogen degrades.

At the anode, the hydrogen sulfide affects degradation of catalytic activity more significantly than SO₂ as described above. Since the sulfur oxide is easily converted into hydrogen sulfide under reduction atmosphere in which hydrogen exists on the noble metal catalyst, it may sometimes affect degradation of catalytic activity as in the hydrogen sulfide, depending on the type of the catalyst and gas atmosphere. Since Japanese environmental criteria of sulfur oxide concentration is 0.04 ppm, the sulfur oxide may affect the catalyst characteristic in the long term in the fuel cell installed near roads with a lot of traffic volumes.

In addition to the hydrogen sulfide, formaldehyde, which is the impurity contained in the air for air-breathing, may poison the anode of the fuel cell. As represented below, it is assumed that, at the anode, the formaldehyde is less likely to be oxidized than the CO, because of difference in the standard potential, and tends to poison the catalyst.
HCOOH(aq)+2H⁺+2e⁻⇄HCHO(aq)+2H₂O 0.034V
CO₂(g)+2H⁺+2e⁻⇄CO(g)+H₂O −0.12V

Aldehydes other than the formaldehyde are more stable than the formaldehyde, and are therefore less likely to be oxidized.

The amount of the CO selective oxidation catalyst is easily increased. If the amount of the anode catalyst is increased, diffusability of the gas inside the fuel cell degrades, causing flooding. It is therefore difficult to reduce influence of catalyst poisoning by increasing the amount of the anode catalyst.

In addition to the hydrogen sulfide and the formaldehyde, organic compounds which are incombustible and volatile may poison the anode of the fuel cell. The organic compounds which are incombustible and volatile are sometimes contained in large quantity in air, depending on the position of the fuel cell system installed. For example, toluene which is a volatile organic compound contained in a paint or the like is incombustible and is not substantially oxidized and decomposed at 200° C. or lower even if the anode catalyst is comprised of noble metal. So, it remains on the catalyst and acts as a poisoning substance under temperature conditions (70 to 80° C.) in which the anode electrocatalyst operates. According to Foul Smell Control Law in Japan, regulation criterion of toluene is 10 ppm in a primary area. In places where smell of paint is always filling, influence of toluene is significant. Therefore, in environments where incombustible organic substances (including fatty acid) are always present, the organic substances may cause catalyst poisoning.

In addition to the above mentioned impurities, basic compounds such as ammonia or amine may poison the anode of the fuel cell, because they neutralize a polymer electrolyte membrane, causing degradation of performance of the fuel cell.

Examples of air which may arise problems in the fuel cell system may be air for purging remaining gas or air for autothermal reaction. Such air is supplied to the reformer that generates the reformed gas and contains the impurities. The amount of air is 100 Nl per supply and 8 Nl/min which are more than that of the air for air-breathing. As a result, the minute amount of impurities contained in the air unavoidably degrade the reforming catalyst in a long-time operation. How the air degrades the reforming catalyst will be explained below.

When the air is supplied to the reformer through an inlet thereof, Ru catalyst which is the reforming catalyst is most significantly affected. If the reforming reaction is conducted under the condition in which the sulfur compound exists at the active site of the catalyst, deposition of carbon from the fuel on the catalyst is promoted, reducing a conversion at which the fuel is converted into hydrogen.

In addition, since noble metal catalysts such as Pt/CeZrOx and Pt/TiO₂ are typically used in the shift converter and the CO selective oxidation portion which are positioned downstream of the reformer, the hydrogen sulfide that has passed through the reformer poisons CeZrOx and TiO₂ which are carriers of the noble metal catalysts of the shift converter and the CO selective oxidation portion, causing degradation of activation of water and degradation of the catalyst characteristic.

Specifically, when 300 g of 2 wt % Ru/alumina catalyst is used as the reforming catalyst, the amount of Ru is 0.06 mol. It is assumed that if the air containing 0.5 ppm hydrogen sulfide is flowed at 100 Nl per purge operation, the poisoning substance is accumulated to the amount that may negatively affect the catalyst characteristics after the purge operations several hundreds times or several thousands times. The fuel cell system that performs start-up and stop operations every day performs the start-up and stop operations 3650 times for ten years. So, in a long-time use, this effect is negligible.

In a case where 300 g of 1 wt % Pt—1 wt % Rh/ZrO₂ catalyst is used as the reforming catalyst, if the air containing 0.5 ppm hydrogen sulfide is sent to the reformer at 8 Nl/min, then the poisoning substance is accumulated to the amount that may negatively affect the catalyst characteristic in several hundreds to several thousands hours. Since the air for autothermal reaction is supplied in large amount, the impurities are accumulated and tend to affect the catalyst in a short time even if they are contained in minute amount in the air.

Thus far, poisoning of the catalyst by the hydrogen sulfide has been described. The concentration of the hydrogen sulfide in the air may be 0.05 to 10 ppm in volcano areas or hot spring areas. Also, since the concentration of the hydrogen sulfide tends to be high near water-purifier tanks, it is assumed that degradation of the catalyst may be accelerated.

The present invention has been made in view of the above mentioned problems. An object of the present invention is to provide a fuel cell system that is capable of maintaining a stable operation for a long-time period by removing impurities from air which is supplied thereto.

Means for Solving the Problems

In order to achieve the above mentioned objective, a fuel cell system according to a first invention comprises a hydrogen generator including a reformer configured to generate a hydrogen-rich gas containing carbon monoxide from a fuel containing hydrocarbon and water; a shift converter configured to generate hydrogen and carbon dioxide from the carbon monoxide in the hydrogen-rich gas and the water; and a carbon monoxide removing portion configured to reduce the carbon monoxide in the hydrogen-rich gas which has not been removed in the shift converter; a fuel cell configured to generate power using the hydrogen-rich gas supplied from the hydrogen generator and an oxidizing gas; an air supply portion configured to supply air to at least one of a position upstream of the reformer in a flow of the fuel and a position between the carbon monoxide removing portion and the fuel cell in the flow of the fuel; and an impurity removing means configured to remove an impurity gas from the air.

A fuel cell system of a second invention which is according to the first invention further comprise an air supply portion configured to supply air to an upstream side of the reformer in the flow of the fuel; and an impurity removing means configured to remove a sulfur compound from the air.

A fuel cell system of a third invention which is according to the first invention further comprise an air supply portion configured to supply the air to the position between the carbon monoxide removing portion and the fuel cell in the flow of the fuel; and an impurity removing means configured to remove ammonia, amine, fatty acid, hydrogen sulfide, and aldehyde from the air.

In a fuel cell system of a fourth invention which is according to the first invention, the reformer is configured to generate the hydrogen-rich gas containing the carbon monoxide from the fuel containing the hydrocarbon, the water, and the air.

In a fuel cell system of a fifth invention which is according to the first invention, the impurity removing means has an adsorbing agent or an absorbing agent of hydrogen sulfide.

In a fuel cell system of a sixth invention which is according to the first invention, the impurity removing means has an adsorbing agent or an absorbing agent of sulfur oxide.

In a fuel cell system of a seventh invention which is according to the first invention, the impurity removing means has a catalytic combustor.

In a fuel cell system of an eighth invention which is according to the sixth invention, the impurity removing means has a catalytic combustor located upstream of the adsorbing agent or the absorbing agent of the sulfur oxide in a flow of the air.

In a fuel cell system of a ninth invention which is according to the seventh invention, the catalytic combustor is positioned to exchange heat with the hydrogen generator or with an exhaust gas resulting from combustion which is used to heat the hydrogen generator.

In a fuel cell system of a tenth invention which is according to the sixth invention, the adsorbing agent or the absorbing agent of the sulfur oxide is positioned to exchange heat with the hydrogen generator or with an exhaust gas resulting from combustion which is used to heat the hydrogen generator.

In a fuel cell system of an eleventh invention which is according to the eighth embodiment, the catalytic combustor functions as the adsorbing agent or the absorbing agent of the sulfur oxide and has a catalyst containing noble metal and alkaline earth metal, the catalytic combustor being positioned to exchange heat with the hydrogen generator or with an exhaust gas resulting from combustion which is used to heat the hydrogen generator.

### EFFECTS OF THE INVENTION

The present invention provides a fuel cell system that is capable of maintaining a stable operation during a long-time period.

### BRIEF DESCRIPTION OF THE DRAWINGS

FIG. 1 is a view schematically showing a construction of a fuel cell system according to an embodiment 1 of the present invention;

FIG. 2 is a view schematically showing a construction of a fuel cell system according to an embodiment 2 of the present invention;

FIG. 3 is a view schematically showing a construction of a fuel cell system according to an example 5 of the present invention; and

FIG. 4 is a view schematically showing a construction of a fuel cell system according to an example 7 of the present invention.

### EXPLANATION OF REFERENCE NUMBERS

1 reformer

2 shift converter

3 CO selective oxidation portion

4 polymer electrolyte fuel cell (PEFC)

5 hydrogen sulfide absorbing portion

6 reformer air supply portion

7 valve

8 CO selective oxidation air supply portion

9 anode air-breathing air supply portion

10 cathode air supply portion

11 heat exchanger

12 catalytic combustor

13 sulfur oxide absorbing portion

14 catalytic combustor

15 fuel supply portion

16 zeolite based adsorption and desulfurization portion

17 water supply portion

18 water evaporator

19 reformer heater

20 hydrogen generator

### BEST MODE FOR CARRYING OUT THE INVENTION

Hereinafter, embodiments of the present invention will be described with reference to the drawings.

### Embodiment 1

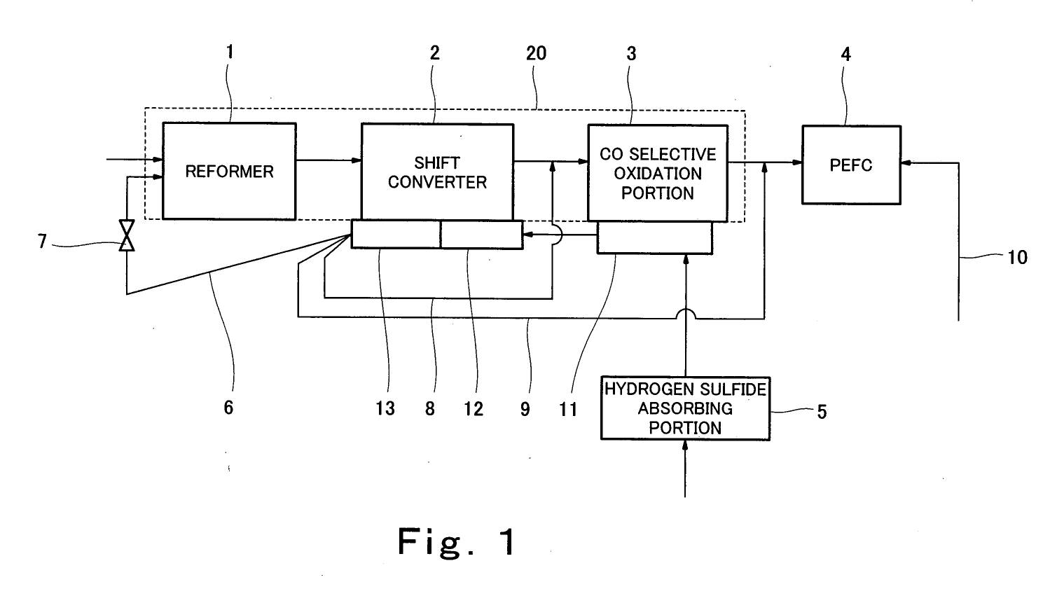

FIG. 1 is a view schematically showing a construction of a fuel cell system according to an embodiment 1 of the present invention. As shown in FIG. 1, the fuel cell system of the embodiment 1 comprises a hydrogen generator 20 configured to generate a hydrogen-rich gas. The hydrogen generator 20 includes a reformer 1 which is filled with Ru/alumina catalyst and is configured to generate a hydrogen-rich gas containing carbon monoxide from fuel containing hydrocarbon and water. The hydrogen generator 20 further includes a shift converter 2 which is positioned downstream of the reformer 1 in a flow of the fuel and is filled with Pt/CeZrOx catalyst which is an oxidation resistant shift reaction catalyst. The shift converter 2 reduces side-reaction product CO produced in the reformer 1. The hydrogen generator 20 further includes a CO selective oxidation portion (carbon monoxide removing portion) 3 which is positioned downstream of the shift converter 2 and is filled with Ru/alumina catalyst which is the selective oxidation catalyst. The CO selective oxidation portion 3 further reduces the CO which has not been completed in the shift converter 2.

A PEFC (polymer electrolyte fuel cell) 4 which is an example of the fuel cell of the present invention is installed downstream of the CO selective oxidation portion 3 and is configured to generate power using the hydrogen-rich gas containing reduced CO as an anode gas. By way of example, an anode catalyst of the fuel cell is Pt—Ru/C catalyst. The fuel cell system of the embodiment 1 is equipped with a cathode air supply portion 10 configured to supply, to a cathode side of the PEFC 4, air from which impurities have been removed.

A reformer air supply portion 6 is positioned upstream of the reformer 1 in a gas passage from the reformer 1 to the PEFC 4, and is configured to supply, to the reformer 1, air for purging a remaining gas from the fuel cell system in a stopped state of the fuel cell system, or air for causing autothermal reaction to occur in an operation of the fuel cell system. In addition, a CO selective oxidation air supply portion 8 is coupled to a position of the gas passage between the shift converter 2 and the selective oxidation portion 3 and is configured to supply air to the CO selective reaction portion 3. Further, an anode air-breathing air supply portion 9 is coupled to a position of the gas passage between the CO selective oxidation portion 3 and the PEFC 4.

The fuel cell system of the embodiment 1 further comprises a hydrogen sulfide absorbing portion 5 configured to remove hydrogen sulfide from the air supplied to each of the reformer air supply portion 6, the CO selective oxidation air supply portion 8, and the anode air-breathing air supply portion 9. A heat exchanger 11 is positioned downstream of the hydrogen sulfide absorbing portion 5 in a flow of the air. The heat exchanger 11 is disposed in contact with the CO selective oxidation portion 3 to exchange heat with the CO selective oxidation portion 3. A catalytic combustor 12 having a Pt/alumina catalyst is positioned downstream of the heat exchanger 11. The catalytic combustor 12 is disposed in contact with the shift converter 2 to exchange heat with the shift converter 2. A sulfur oxide absorbing portion 13 having calcium oxide is positioned downstream of the catalytic combustor 12. The sulfur oxide absorbing portion 13 is disposed to exchange heat with the shift converter 2. The air is supplied from the sulfur oxide absorbing portion 13, to the reformer air supply portion 6, the CO selective oxidation air supply portion 8, and the anode air-breathing air supply portion 9. A valve 7 is provided between the reformer air supply portion 6 and the sulfur oxide absorbing portion 13 below.

An operation method of the fuel cell system of the embodiment 1 configured as described above (a first operation method of the fuel cell system of the present invention) will be described.

Referring to FIG. 1, a fuel that has flowed through an adsorbing agent that adsorbs and removes a sulfur component from the fuel is mixed with water, heated, and is introduced into the reformer 1. The temperature of the steam reforming catalyst varies depending on the type of the fuel. When the fuel is the city gas, the city gas which has just exited from the steam reforming catalyst is kept at approximately 650° C. The hydrogen-rich gas generated in the reformer 1 flows through the shift converter 2, and the CO selective oxidation portion 3. Thereby, the side-reaction product CO generated in the reformer 1 is reduced. The resulting hydrogen-rich gas is supplied to the PEFC 4 as the anode gas. As defined herein, the city gas is a natural gas containing methane as a major component.

The air flows through the hydrogen sulfide absorbing portion 5 and is heated in the heat exchanger 11 in contact with the CO selective oxidation portion 3.

Then, the air flows through the catalytic combustor 12 kept at 250° C. during a normal operation, and thereafter flows through the sulfur oxide absorbing portion 13 kept at 300° C. The catalytic combustor 12 and the sulfur oxide absorbing portion 13 are in contact with the shift converter 2 and are heated. It shall be understood that the hydrogen sulfide is oxidized into the sulfur oxide on the Pt/alumina catalyst, and is absorbed into the sulfur oxide absorbing portion 13 if the hydrogen sulfide absorbing portion 5 is omitted. Nonetheless, since a part of the hydrogen sulfide remains on the Pt/alumina catalyst, it is therefore desirable to remove the hydrogen sulfide in advance in the hydrogen sulfide absorbing portion 5.

After flowing through the sulfur oxide absorbing portion 13, the air is sent, through the CO selective oxidation air supply portion 8 and the anode air-breathing air supply portion 9, to the CO selective oxidation portion 3 and the anode of the PEFC 4 at, for example, 0.5 Nl/min and 0.3 Nl/min, respectively. Alternatively, the air that gas flowed through the sulfur oxide absorbing portion 13 may be supplied to the cathode air supply portion 10 and used as the cathode air.

A combustible gas such as hydrogen or the city gas remaining within the fuel cell system in a stopped state of the fuel cell is hazardous and therefore must be purged from the system using air. In the embodiment 1, after the reformer 1 is cooled to a temperature at which the steam reforming catalyst Ru is not oxidized, the valve 7 is opened.

After flowing through the sulfur oxide absorbing portion 13, the air is supplied to the reformer 1, through the reformer air supply portion 6, to sequentially replace the combustible gas remaining in the shift converter 2, the CO selective oxidation portion 3, and the PEFC 4 at 10 Nl/min for 10 minutes, for example.

It is desirable to use alkaline earth metal oxides, oxides of transition metals such as Mn, Co, Fe, Cu, or Zr, oxides of rare earth metal such as Ce, as the adsorbing agent or the absorbing agent of the sulfur oxide in the sulfur oxide absorbing portion 13. Some of the absorbing agent is desirably heated for use. In the case of CaO, the sulfur oxide is absorbed into CaO at 300 to 600° C. according to formulae (3) and (4) represented below.
2SO₂+CaO→2CaSO₃ (3)
2CaSO₃+SO₂→2CaSO₄+1/2S₂ (4)

Alternatively, alkaline component impregnated charcoal and zeolite may be used as sulfur oxide absorbing agents.

Exemplary hydrogen sulfide adsorbing agents of the hydrogen sulfide absorbing portion 5 are zeolite such as MS4A and the alkaline component impregnated charcoal.

Exemplary catalyst for causing the organic compound to combust in the catalytic combustor 12 is Pt/alumina. Pt—Rh based catalyst having resistance to sulfur poisoning is desirably used in the catalytic combustor 12. Since the hydrogen sulfide is converted into the sulfur oxide using the combustion catalyst having resistance to sulfur poisoning and high oxidation activity, the hydrogen sulfide absorbing portion 5 may be omitted. While organic compound is desirably catalytically combusted for maintenance-free, it may be adsorbed and removed by using active carbon filter or the like.

In a second operation method, hydrogen is generated by autothermal reaction in an operation of the fuel cell system of the embodiment 1. The catalyst of the reformer 1 is Pt—Rh/ZrO₂.

In the operation of the fuel cell system of the embodiment 1, air is supplied from the reformer air supply portion 6. Thereby, the hydrocarbon based fuel is oxidized. Since the oxidation of the hydrocarbon is an exothermic reaction, so-called autothermal reaction occurs, which facilitates the steam reforming reaction which is an endothermic reaction. Here, the air is supplied at, for example, 8 Nl/min. The second operation method is effective when performed during start-up of the fuel cell system, because it reduces start-up time.

In the embodiment 1, the air is supplied to the reformer air supply portion 6 through the hydrogen sulfide absorbing portion 5, the catalytic combustor 12, and the sulfur oxide absorbing portion 13. Alternatively, the air may be supplied to the reformer air supply portion 6 through the hydrogen sulfide absorbing portion 5 and the sulfur oxide absorbing portion 13 without through the catalytic combustor 12. Thereby, the sulfur compound is removed from the air supplied to the reformer 1.

### Embodiment 2

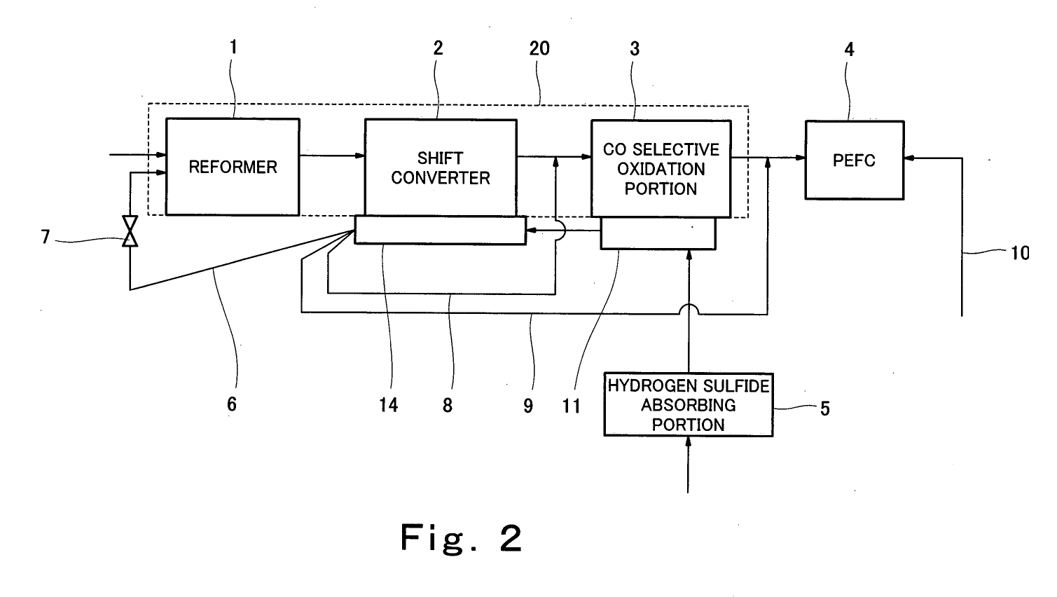

FIG. 2 is a view schematically showing a construction of a fuel cell system according to an embodiment 2 of the present invention. As shown in FIG. 2, the fuel cell system of the embodiment 2 is identical to that of the embodiment 1 except that the catalytic combustor 14 has sulfur oxide absorbing capability. In FIG. 2, the same reference numerals as those in FIG. 1 denote the same or corresponding parts, which will not be described in detail. Hereinbelow, difference will be described.

The catalytic combustor 14 in the fuel cell system of the embodiment 2 has a pellet-shaped catalyst carrying barium oxide and platinum on alumina. The catalytic combustor 14 corresponds to the catalytic combustor 12 and the sulfur oxide absorbing portion 13 of the embodiment 1. Sulfur dioxide or hydrogen sulfide is oxidized into sulfur trioxide on heated noble metal and is absorbed into barium oxide present in the vicinity of the noble metal. The barium oxide is exemplary and other alkaline earth metal oxides such as calcium oxide may be used.

The noble metal catalyst allows organic substances such as toluene and sulfur compounds to be combusted at relatively low temperatures. In the manner described above, the organic compound, the sulfur oxide, and the hydrogen sulfide are effectively removed.

The carbon monoxide removing portion of the present invention, which corresponds to the CO selective oxidation portion 3 in the embodiments 1 and 2, may remove carbon monoxide by methanation reaction rather than the CO selective oxidation, or otherwise reduce the CO by using a combination of the methanation reaction and the CO selective oxidation. It is necessary to reduce the carbon monoxide as much as possible in the hydrogen-rich gas supplied from the shift converter 2. When only the methanation reaction is conducted in the carbon monoxide removing portion, the CO selective oxidation air supply portion 8 may be omitted.

The impurity removing portion of the present invention corresponds to the hydrogen sulfide absorbing portion 5, the heat exchanger 11, the catalytic combustor 12, and the sulfur oxide absorbing portion 13 in the embodiment 1, and to the hydrogen sulfide absorbing portion 5, the heat exchanger 11, and the combustor 14 in the embodiment 2. Alternatively, as described above, the hydrogen sulfur absorbing portion 5 may be omitted. Nonetheless, since a part of the hydrogen sulfide remains on the Pt/alumina of the catalytic combustor 12, it is desirably removed in advance in the hydrogen sulfide absorbing portion 5.

The air supply portion positioned upstream of the reformer 1 of the present invention corresponds to the reformer air supply portion 6 of the embodiments 1 and 2. Also, the air supply portion of the present invention positioned between the carbon monoxide removing portion and the fuel cell corresponds to the anode air-breathing air supply portion 9 of the embodiments 1 and 2. While in the embodiment 1, the impurity is removed from the air supplied to the reformer air supply portion 6 and from the air supplied to the anode air-breathing air supply portion 9, it may alternatively be removed from the air supplied to one of them. Nonetheless, in order to carry out stable operation for a long time period, the impurity may be removed from the air supplied to both of them.

The catalytic combustor 12 and the sulfur oxide absorbing portion 13 of the embodiment 1 are disposed in contact with the shift converter 2 and is configured to exchange heat with the shift converter 2. Alternatively, the catalytic combustor 12 and the sulfur oxide absorbing portion 13 may be disposed to exchange heat with an exhaust gas resulting from combustion which is used to heat the shift converter 2 without contacting the shift converter 2, or otherwise may be disposed in contact with the CO selective oxidation portion 3 or the like instead of the shift converter 2, so long as the catalytic combustor 12 is heated up to a temperature suitable for catalytic combustion and the sulfur oxide absorbing portion 13 is heated up to a temperature suitable for absorption or adsorption of the sulfur oxide. The same applies to the catalytic combustor 14 of the embodiment 2.

### EXAMPLES

Hereinafter, examples of the fuel cell system and the operation method thereof will be described.

### Example 1

In an example 1, a membrane electrode assembly (hereinafter referred to as MEA) was produced. Gas and air were caused to flow through the MEA to conduct test of influence of the impurities in the air.

First, a manufacturing method of the MEA will be described.

Water and perfluorosulfonic acid ionomer ethanol solution (Flemion: 9 wt % perfluorosulfonic acid ionomer produced by ASAHI Glass Co. Ltd) were added to Pt/C catalyst, and catalyst ink was adjusted so that weight ratio of Flemion to carbon black was 1:1. The catalyst ink was applied to a carbon paper by a doctor blade method such that the amount of Pt was 0.3 mg/cm² and was dried at 60° C., thereby producing a cathode gas diffusion electrode layer.

An anode gas diffusion electrode layer was produced from 30 wt % Pt—24 wt % Ru/C such that the amount of Pt was 0.3 mg/cm² in the same manner.

A Nafion 112 membrane (registered mark, produced by Dupont) was sandwiched between the two gas diffusion electrode layers produced as described above and was joined by hot pressing at 130° C., thereby manufacturing the membrane electrode assembly (MEA).

The MEA was caused to operate using air and hydrogen under the condition in which oxygen utilization ratio was 40%, hydrogen utilization ratio was 70%, cell temperature was 75° C., cathode dew point was 65° C., anode dew point was 70° C. and output current was 0.2 A/cm². In this case, a gas mixture containing simulation gas of 50 ppm CO—20% CO₂/H₂ and 0.0013 Nl/min air containing 20 ppm hydrogen sulfide was flowed through the anode. An output voltage of the MEA was 0.715V in an initial stage at start of power generation, but decreased to 0.642V after an elapse of 1000 hours.

An experiment was conducted in such a manner that air containing 20 ppm hydrogen sulfide was flowed through a hydrogen sulfide absorbing agent filled with pellets of zeolite (MS4A), and then through the MEA. As a result, the voltage was 0.707V after an elapse of 1000 hours, and thus voltage drop was suppressed.

Thus, it has been found that the voltage drop occurred in the MEA when the hydrogen sulfide was present as the impurity in the anode air-breathing air, and was suppressed by the impurity removing agent that removes the hydrogen sulfide.

Then, air containing 20 ppm trimethylamine instead of the hydrogen sulfide, was mixed into the above mentioned simulation gas and was flowed through the anode. The output voltage of the MEA was 0.720V in an earlier stage of power generation, but decreased to about 0.5V after an elapse of 1000 h. Thus, the basic compound caused the voltage drop in the MEA.

### Example 2

Methane humidified in S/C (steam/carbon) ratio of 3:1 was flowed through 1.3 cc of 2 wt % Ru/alumina catalyst pellets which are a reforming catalyst under the condition in which GHSV (gas highest space velocity) was 3200 h⁻¹ and the temperature was 640° C. to be subjected to steam reforming. As a result, the conversion of methane into hydrogen was 86%. Thereafter, the catalyst pellets were cooled to a room temperature, and then air containing 20 ppm hydrogen sulfide was flowed through the catalyst pellets at 0.25 Nl/min for 20 h. Thereafter, the steam reforming reaction was conducted under the same conditions, and the conversion was measured. As a result, the conversion decreased to 70%.

In a similar test, air containing 20 ppm hydrogen sulfide was flowed through a hydrogen sulfide absorbing agent filled with zeolite (MS4A) pellets, and then through the steam reforming catalyst. After flowing the air through the catalyst for 20 h, the characteristic of the steam reforming catalyst was measured, and the conversion was 85%.

As should be understood from above, the steam reforming catalyst was degraded after an elapse of several tens hours if purge air for the steam reforming catalyst contained the hydrogen sulfide as the impurity, and the impurity removing agent capable of removing the hydrogen sulfide suppressed degradation of the catalyst.

### Example 3

A gas mixture containing methane, water and air in a mol ratio of 1:1.5:3 was flowed in 3 cc of 1 wt % Pt—1 wt % Rh/ZrO₂ catalyst pellets which are an autothermal reaction catalyst under the condition in which GHSV was 1000 h⁻¹ and the temperature was 750° C. to be subjected to the steam reforming reaction. The air contained 20 ppm hydrogen sulfide. As a result, the conversion at which methane is converted into hydrogen was 94.6% just after start of the experiment, but decreased to 84.7% after an elapse of 400 h.

A similar autothermal reaction test was conducted in such a manner that air containing 20 ppm hydrogen sulfide was flowed through a hydrogen sulfide absorbing container filled with hydrogen sulfide absorbing agent pellets comprised of zeolite (MS4A), and then through the catalyst pellets. After an elapse of 400 h, the conversion was 94.2%.

From the example 3, it has been verified that the catalyst characteristic of the reformer 1 was degraded when the air which was supplied to the reformer 1 to cause the autothermal reaction to occur contains hydrogen sulfide as the impurity. It has also been verified that the impurity removing agent capable of removing the hydrogen sulfide suppressed degradation of the catalyst characteristic.

### Example 4

In the autothermal reaction, the sulfur compound is finally converted into the hydrogen sulfide, a part of which is supplied to a catalyst on a downstream side. Therefore, influence of the hydrogen sulfide on the shift reaction catalyst and the selective oxidation catalyst was researched.

A test gas of 11% CO—12% CO₂/H₂ was supplied to 4 cc of 2 wt % Pt/CeZrOx pellet-shaped shift reaction catalyst. The test gas was flowed through a bubbler. The resulting test gas had a dew point of 57° C. and was supplied to the shift reaction catalyst. GHSV was set to 3000 h⁻¹. Further, a gas with a composition of 500 ppm H₂S/N₂ was mixed into the test gas so that the concentration of the hydrogen sulfide of the test gas in a dry state was 20 ppm. The shift reaction catalyst was kept at 230° C. The test gas was flowed on the shift reaction catalyst for 1000 h. The CO concentration in a dry state on an exit side of the shift reaction catalyst was 0.41% just after the test gas started to be flowed, but increased up to 0.48% after an elapse of 1000 hours.

Further, a test gas of 0.5% CO—20% CO₂/H₂ was supplied to a CO selective oxidation catalyst comprised of a honeycomb carrying 1.5 g/l Ru and having a diameter of 2 cm and a thickness of 1 cm. As in the above test of the shift reaction catalyst, the test gas having a dew point of 70° C. and containing 20 ppm hydrogen sulfide in a dry state was supplied to the CO selective oxidation catalyst. In addition, the air was mixed into the test gas so that O₂/CO was 1.5. GHSV was set to 9300 h⁻¹. The test gas was flowed through the CO selective oxidation catalyst at a catalyst temperature of 150° C. for 10 h. The CO concentration on an exit side of the CO selective oxidation catalyst was 112 ppm just after the test gas started to be flowed, but increased up to 322 ppm after an elapse of 10 hours.

As should be appreciated from the above, it has been found that the shift reaction catalyst, and the CO selective oxidation catalyst degraded their characteristics by a minute amount of hydrogen sulfide.

### Example 5

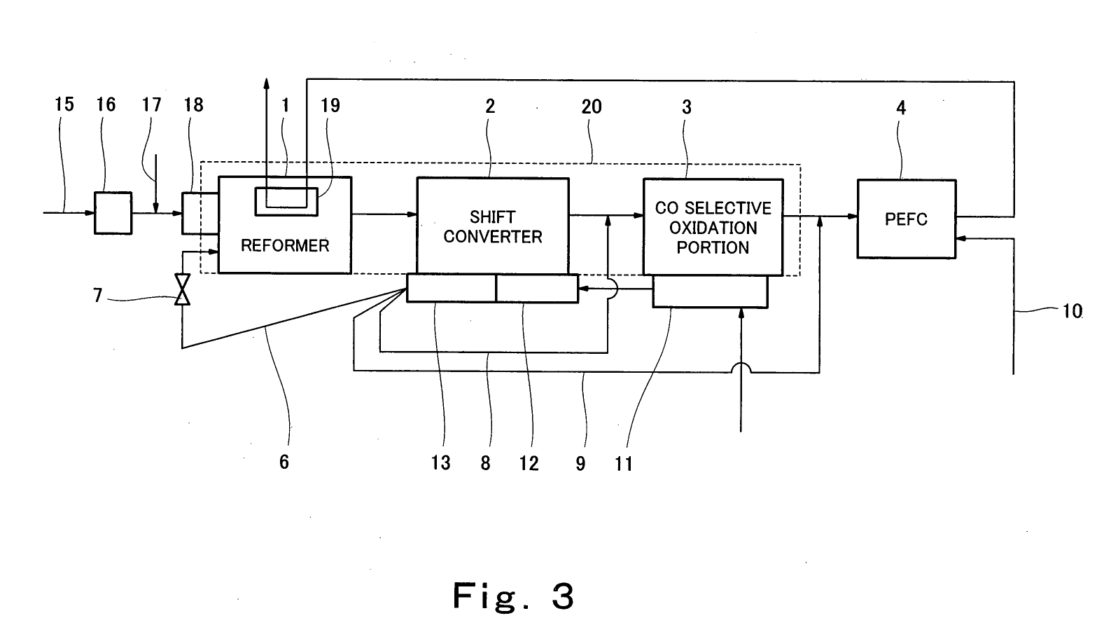

FIG. 3 is a view schematically showing a construction of a fuel cell system according to an example 5. While the fuel cell system of the example 5 is identical in basic construction to the fuel system of the embodiment 1, the hydrogen sulfide absorbing portion 5 is omitted in the example 5, and the example 5 shows the construction in more detail. Therefore, the configuration which is not illustrated in the embodiment 1 will be described.

As shown in FIG. 3, the fuel cell system of the example 5 comprises a fuel supply portion 15 configured to supply the city gas. A zeolite based adsorption and desulfurization portion 16 is disposed downstream of the fuel supply portion 15. A water supply portion 17 is connected to a position of the gas passage which is downstream of the zeolite based adsorption and desulfurization portion 16. A water evaporator 18 is disposed downstream of the water supply portion 17. The reformer 1 is cylindrical. The water evaporator 18 is disposed on an outer periphery of the cylindrical reformer 1 to enable waste heat in the steam reforming reaction to be utilized. A reformer heater 19 including an off gas burner is installed at the center of the reformer 1 and is configured to heat the reformer 1. The reformer heater 19 heats the reformer 1 by combusting an anode off gas exhausted from the fuel cell 4. Ru catalyst is disposed around the off gas burner. The city gas containing steam was supplied to the Ru catalyst from above to below.

The reformer 1 was filled with 0.3 L Ru catalyst. The shift converter 2 was filled with 2 L Pt/CeZrOx catalyst. The CO selective oxidation portion 3 was filled with 0.2 L Ru catalyst. The CO selective oxidation catalyst was comprised of a honeycomb structure catalyst body and other catalysts was comprised of a pellet-shaped catalyst body.

Using the fuel cell system of the example 5 constructed above, an experiment was conducted as described below.

The city gas was supplied from the fuel supply portion 15 at 4 Nl/min. The water adjusted to have S/C of 3 was supplied from the water supply portion 17 to the reformer 1. The combustion amount in the reformer heater 19 was adjusted so that the temperature of the Ru catalyst inside the reformer 1 became 650° C. A power generation portion in the fuel cell was caused to generate power in such a manner that DC power was 1.2 kW. Separately from the cathode air, 20 ppm toluene and 20 ppm hydrogen sulfide were added to the anode air-breathing air, the CO selective oxidation air, and the purge air. This air was flowed through the heat exchanger 11 disposed around the CO selective oxidation portion 3 to be heated there. Then, the air was flowed through the catalytic combustor 12 disposed in contact with the shift converter 2 and including the Pt/alumina catalyst kept at 250° C. Thereafter, the air was led to the sulfur oxide absorbing portion 13 disposed in contact with the shift converter 2 and including CaO kept at 300° C. After flowing through the sulfur oxide absorbing portion 13, the air was supplied to the CO selective oxidation portion 3 at 0.5 Nl/min and to the anode catalyst at 0.3 Nl/min. This was a fuel cell system A.

The fuel cell system A was operated for 12 h and was stopped. In a stopped state of the fuel cell system A, when the temperature of the steam reforming catalyst decreased to 200° C., the air containing 20 ppm toluene and 20 ppm hydrogen sulfide was flowed at 10 Nl/min, from the reformer air supply portion 7 through the catalytic combustor 12 and the sulfur oxide absorbing portion 13, to purge the remaining gas therein and was cooled. DSS (daily Start-Stop) operation was conducted in such a manner that the fuel cell system A operated for 12 h and then was stopped for 12 h. As a result, the fuel cell system A was able to operate stably even after the operation continued for 300 h.

In the fuel cell system A, the catalytic combustor 12 and the sulfur oxide absorbing portion 13 were arranged in a reversed order. The resulting fuel cell system was caused to perform the DSS operation. As a result, stability of the fuel cell system was lower than that of the fuel cell system A.

In the fuel cell system A, a hydrogen sulfide absorbing portion filled with hydrogen absorbing agent pellets comprised of zeolite (MS4A) was provided downstream of the catalytic combustor 12, instead of the sulfur oxide absorbing portion 13. In this case, the air was flowed through the zeolite (MS4A) after cooled to several tens degrees. The resulting fuel cell system was caused to perform the DSS operation. As a result, stability of the fuel cell system also degraded.

From the fuel cell system A, the catalytic combustor 12 and the sulfur oxide absorbing portion 13 were omitted, and in the resulting fuel cell system, the air containing 20 ppm toluene was directly flowed for the anode air-breathing, the CO selective oxidation, and the purge. In the same manner, the fuel cell system was caused to perform the DSS operation. As a result, a cell voltage decreased after the fuel cell system operated for 280 h, making it difficult to generate power.

As should be appreciated from the above, since the catalytic combustor 12 is disposed at a position of the passage of the air for use as the anode air-breathing air, the CO selective oxidation air, and the purge air, i.e., the air to be mixed into the material or the hydrogen-rich gas produced from the material, and the sulfur oxide absorbing portion 13 including the adsorbing agent or the absorbing agent is positioned downstream of the catalytic combustor 12, the catalytic combustor 12 functions as the impurity removing means that removes incombustible and volatile organic compounds. In addition, the catalytic combustor 12 and the sulfur oxide absorbing portion 13 function as the impurity removing means that removes the sulfur compounds represented by the hydrogen sulfide and the sulfur oxide. As a result, the fuel cell system of the present invention was able to operate stably even when atmospheric air which was a supply source of the air that was mixed into the material or the hydrogen-rich gas produced from the material contained incombustible and volatile organic compounds and sulfur compounds.

### Example 6

The fuel cell system A of the example 5 performed a second operation method in which 0.311 wt % Pt—1 wt % Rh/ZrO₂ catalyst was used as the reforming reaction catalyst, and the air was supplied from the reformer air supply portion 6 to cause the autothermal reaction to occur during the operation of the fuel cell system A. The autothermal air was supplied at 8 Nl/min during a rated power operation. As in the example 5, the DSS test was conducted. The PEFC 4 was able to operate stably after 3000 h continued operation even when the air containing 20 ppm toluene and 20 ppm hydrogen sulfide was added.

From the fuel cell system A, the catalytic combustor 12 and the sulfur oxide absorbing portion 13 were omitted. The resulting fuel cell system conducted the similar operation test. As a result, the hydrogen concentration of the hydrogen-rich gas flowing on a downstream side of the hydrogen generator 20 decreased after the operation continued for 203 h, i.e., the conversion at which methane is converted into hydrogen in the hydrogen generator 2 decreased, making it difficult to generate power.

Thus, regarding the autothermal air, since the catalytic combustor 12 is disposed at a position of the passage of the air for use as the anode air-breathing air, the CO selective oxidation air, and the purge air, i.e., the air to be mixed into the material or the hydrogen-rich gas produced from the material, and the sulfur oxide absorbing portion 13 including the adsorbing agent or the absorbing agent is positioned downstream of the catalytic combustor 12, the catalytic combustor 12 functions as the impurity removing means that removes incombustible and volatile organic compounds, as in the example 5. In addition, the catalytic combustor 12 and the sulfur oxide absorbing portion 13 function as the impurity removing means that removes the sulfur compounds represented by the hydrogen sulfide and the sulfur oxide. As a result, the fuel cell system of the present invention was able to operate stably even when atmospheric air which was a supply source of the air that was mixed into the material or the hydrogen-rich gas produced from the material contained incombustible and volatile organic compounds and sulfur compounds.

### Example 7

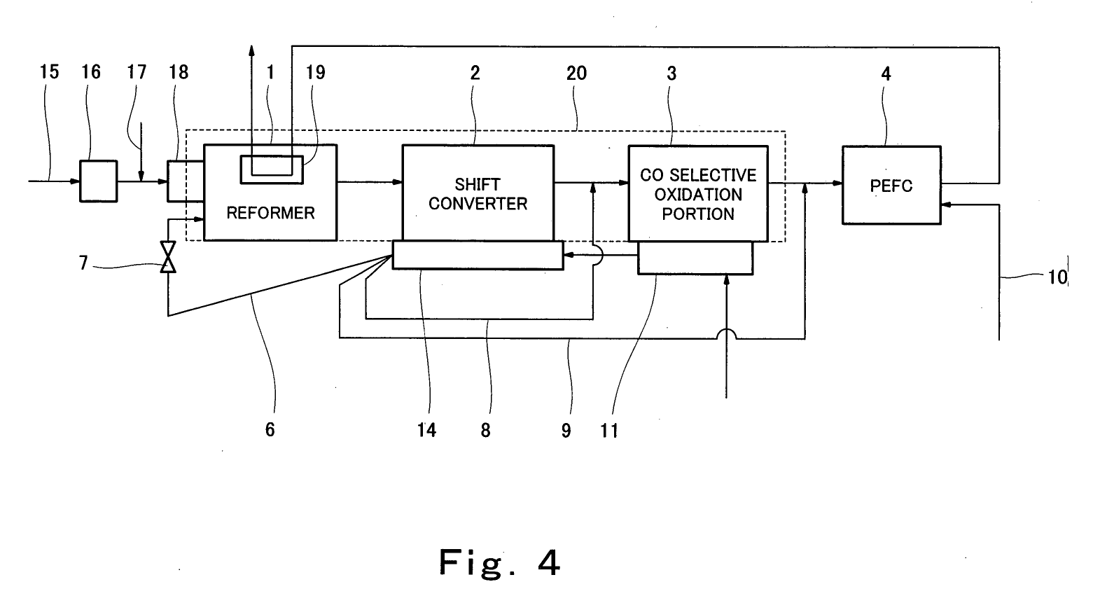

FIG. 4 is a view schematically showing a construction of the fuel cell system according to an example 7. The fuel cell system of the example 7 comprises the catalytic combustor 14 having the sulfur oxide absorbing capability which is illustrated in the embodiment 2, instead of the catalytic combustor 12 and the sulfur oxide absorbing portion 13 in the fuel cell system of the example 5. The construction of this fuel cell system is such that Pt/BaO Al₂ ZrO₃ catalyst is disposed in the catalytic combustor in the fuel cell system A, and the sulfur oxide absorbing portion 13 is omitted from the fuel cell system A.

As the air for use as the anode air-breathing air, the CO selective oxidation air, and the purge air, the air containing 20 ppm toluene and 20 ppm hydrogen sulfide was used. The catalytic combustor 14 was kept at 250° C. The DSS operation was conducted in such a manner that the fuel cell system operated for 12 h and then was stopped for 12 h. As a result, the fuel cell system was able to operate stably even after the operation continued for 3000 h.

As should be appreciated from the foregoing, by using the combustion catalysts containing the noble metal and the alkaline earth metal oxides, the catalytic combustor 14 functions as both of the impurity removing means for removing the volatile organic compounds and the impurity removing means for removing the sulfur compounds such as the hydrogen sulfide and the sulfur oxide. As a result, the fuel cell system of the present invention was able to operate stably even when atmospheric air which was a supply source of the air that was mixed into the material or the hydrogen-rich gas produced from the material contained incombustible and volatile organic compounds and sulfur compounds.

### INDUSTRIAL APPLICABILITY

A fuel cell system of the present invention is capable of maintaining stable operation for a long time period, and is useful as a cogeneration fuel cell system for household use, or the like.

1. A fuel cell system comprising:
a hydrogen generator including a reformer configured to generate a hydrogen-rich gas containing carbon monoxide from a fuel containing hydrocarbon and water; a shift converter configured to generate hydrogen and carbon dioxide from the carbon monoxide in the hydrogen-rich gas and the water; and a carbon monoxide removing portion configured to reduce the carbon monoxide in the hydrogen-rich gas which has not been removed in said shift converter;
a fuel cell configured to generate power using the hydrogen-rich gas supplied from said hydrogen generator and an oxidizing gas;
an air supply portion configured to supply air to at least one of a position upstream of said reformer in a flow of the fuel and a position between said carbon monoxide removing portion and said fuel cell in the flow of the fuel; and
an impurity removing means configured to remove an impurity gas from the air.

2.-11. (canceled)

12. The fuel cell system according to claim 1, wherein said impurity removing means comprises an alkaline earth metal oxide.

13. The fuel cell system according to claim 1, wherein said impurity removing means comprises at least an oxide of metal selected from Mn, Co, Fe, Cu, and Zr.

14. The fuel cell system according to claim 1, wherein said impurity removing means comprises a Ce oxide.

15. The fuel cell system according to claim 1, wherein said impurity removing means comprises alkaline component impregnated charcoal.

16. The fuel cell system according to claim 1, wherein said reformer is configured to generate the hydrogen-rich gas containing the carbon monoxide from the fuel containing the hydrocarbon, the water, and the air.

17. The fuel cell system according to claim 1, wherein said impurity removing means includes a sulfur oxide absorbing portion having an adsorbing agent or an absorbing agent of the sulfur oxide and a catalytic combustor disposed upstream of said sulfur oxide absorbing portion in a flow of the air.

18. The fuel cell system according to claim 17, wherein said catalytic combustor is positioned to exchange heat with said hydrogen generator or with an exhaust gas resulting from combustion which is used to heat said hydrogen generator.

19. The fuel cell system according to claim 17, wherein said sulfur oxide absorbing portion is positioned to exchange heat with said hydrogen generator or with an exhaust gas resulting from combustion which is used to heat said hydrogen generator.

20. The fuel cell system according to claim 17, wherein said catalytic combustor functions as said sulfur oxide absorbing portion and has a catalyst containing noble metal and alkaline earth metal, said catalytic combustor being positioned to exchange heat with said hydrogen generator or with an exhaust gas resulting from combustion which is used to heat said hydrogen generator.
